(19) United States
(12) Patent Application Publication
(10) Pub. No.: US 2025/0124946 A1
(43) Pub. Date: Apr. 17, 2025

(54) EAR-WORN DEVICE PROVIDING ENHANCED NOISE REDUCTION AND DIRECTIONALITY

(71) Applicant: Chromatic Inc., New York, NY (US)

(72) Inventors: Igor Lovchinsky, New York, NY (US); Israel Malkin, Manhattan Beach, CA (US); Jonathan Macoskey, Pittsburgh, PA (US); Philip Meyers, IV, San Francisco, CA (US); Abraham Neben, Hamden, CT (US); Nicholas Morris, Brooklyn, NY (US)

(21) Appl. No.: 18/913,590

(22) Filed: Oct. 11, 2024

Related U.S. Application Data
(60) Provisional application No. 63/590,024, filed on Oct. 13, 2023.

(51) Int. Cl. G10L 25/84; G10L 25/30

(52) U.S. Cl. CPC G10L 25/84; G10L 25/30

(57) ABSTRACT

In some embodiments, an ear-worn device may include adaptive mixing control circuitry configured to control mixing circuitry to mix a speech component of an input audio signal with a noise component of the input audio signal based on a deviation of a short-term level of the noise component of the input audio signal from a long-term level of the noise component of the input audio signal. In some embodiments, an ear-worn device may include beamforming circuitry configured to generate a front audio signal and a back audio signal, and direction-of-arrival circuitry configured to bias an output audio signal based on a difference between the front audio signal and the back audio signal.

### BACKGROUND

### Field

The present disclosure relates to an ear-worn device, such as a hearing aid.

### Related Art

Hearing aids are used to help those who have trouble hearing to hear better. Typically, hearing aids amplify received sound. Some hearing aids attempt to remove environmental noise from incoming sound.

### SUMMARY

Recently, ear-worn devices (e.g., hearing aids) that run neural networks trained to denoise audio signals have been developed. Ear-worn devices may also implement beamforming for focusing on sound from specific directions. Disclosed herein are techniques for enhancing the noise reduction and directionality provided by such ear-worn devices.

Interfering speakers present one type of noise that may be difficult to reduce. Beamforming may be able to attenuate interfering speakers to a certain extent but may not be very effective since the steering of the nulls in adaptive beamforming is usually dominated by ambient noise (at least in loud environments). Additionally, when beamforming is implemented by a hearing aid positioned on a human head in real-world conditions, the directionality pattern may warp (e.g., due to interference from the wearer's ear, head, and/or torso) such that at most a few dB of noise reduction of other speakers may be achieved, even if the null is pointed straight at the other speakers. The inventors have developed methods for preferentially attenuating interfering speakers using a combination of classical beamforming and noise reduction.

The inventors have also developed methods for using spatial information to do noise reduction in such a way that sounds coming from a particular direction (e.g. the front) are boosted while sounds coming from a different direction (e.g. the back) are attenuated. While conventional beamforming techniques may accomplish this to a certain extent, in real-world conditions they typically only provide a few dB of signal-to-noise ratio (SNR) gain. The inventors have also developed methods for adaptive control of how much noise is mixed in with speech, after speech and noise have been separated using a neural network. The adaptive control of noise mixing may be separate from the spatial information-based noise reduction, but the two may both be implemented for enhanced operation.

### BRIEF DESCRIPTION OF DRAWINGS

Various aspects and embodiments of the application will be described with reference to the following figures. It should be appreciated that the figures are not necessarily drawn to scale. Items appearing in multiple figures are indicated by the same reference number in all the figures in which they appear.

FIG. 1 illustrates a data path in an ear-worn device (e.g., a hearing aid), in accordance with certain embodiments described herein;

FIG. 2 illustrates noise reduction circuitry, in accordance with certain embodiments described herein;

FIG. 3 illustrates noise reduction circuitry, in accordance with certain embodiments described herein;

FIG. 4 illustrates noise reduction circuitry, in accordance with certain embodiments described herein;

FIG. 5 illustrates noise reduction circuitry, in accordance with certain embodiments described herein;

FIG. 6 illustrates noise reduction circuitry, in accordance with certain embodiments described herein;

FIG. 7 illustrates noise reduction circuitry, in accordance with certain embodiments described herein;

FIG. 8 illustrates a data path in an ear-worn device (e.g., a hearing aid), in accordance with certain embodiments described herein;

FIG. 9 illustrates noise reduction circuitry, in accordance with certain embodiments described herein;

FIG. 10 illustrates noise reduction circuitry, in accordance with certain embodiments described herein;

FIG. 11 illustrates a data path in an ear-worn device (e.g., a hearing aid), in accordance with certain embodiments described herein;

FIG. 12 illustrates a view of a hearing aid, in accordance with certain embodiments described herein; and

FIG. 13 illustrates the hearing aid of FIG. 12 on a wearer, in accordance with certain embodiments described herein.

### DETAILED DESCRIPTION

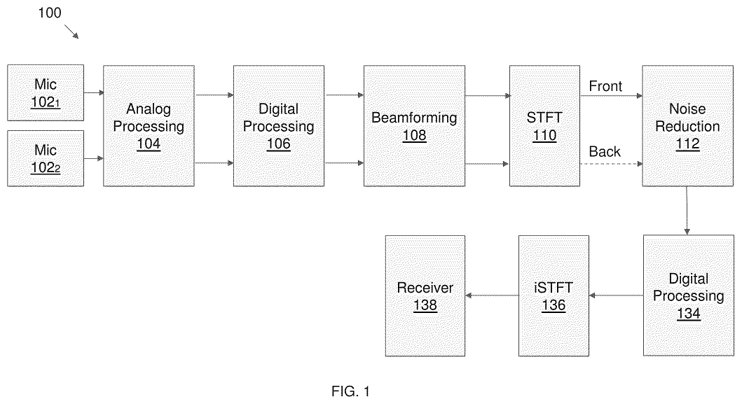

FIG. 1 illustrates a data path 100 in an ear-worn device (e.g., a hearing aid), in accordance with certain embodiments described herein. The data path 100 includes a microphone 102₁, a microphone 102₂, analog processing circuitry 104, digital processing circuitry 106, beamforming circuitry 108, short-time Fourier transformation (STFT) circuitry 110, noise reduction circuitry 112, digital processing circuitry 134, inverse STFT circuitry 136, and a receiver 138. It should be appreciated that the data path 100 may include more circuitry and components than shown (e.g., anti-feedback circuitry, calibration circuitry, etc.) and such circuitry and components may be disposed before, after, or between the circuitry and components illustrated in FIG. 1.

In the data path 100, the analog processing circuitry 104 is coupled between the microphones 102₁ and 102₂ and the digital processing circuitry 106. The digital processing circuitry 106 is coupled between the analog processing circuitry 104 and the beamforming circuitry 108. The beamforming circuitry 108 is coupled between the digital processing circuitry 106 and the STFT circuitry 110. The STFT circuitry 110 is coupled between the beamforming circuitry 108 and the noise reduction circuitry 112. The noise reduction circuitry 112 is coupled between the STFT circuitry 110 and the digital processing circuitry 134. The digital processing circuitry 134 is coupled between the noise reduction circuitry 112 and the inverse STFT circuitry 136. The inverse STFT 136 circuitry is coupled between the digital processing circuitry 134 and the receiver 138. As referred to herein, if element A is described as coupled between element B and element C, there may be other elements between elements A and B and/or between elements A and C.

The microphones 102₁ and 102₂ may be configured to receive sound signals and convert the sound signals into electrical audio signals. The microphones 102₁ and 102₂ may be disposed on the external housing of the ear-worn device. When the ear-worn device is worn, one of the microphones may be closer to the front of the wearer of the ear-worn device and the other microphone may be closer to the back of the wearer of the ear-worn device.

The analog processing circuitry 104 may be configured to perform analog processing on the signals received from the microphones 102₁ and 102₂. For example, the analog processing circuitry 104 may be configured to perform one or more of analog preamplification, analog filtering, and analog-to-digital conversion;

The digital processing circuitry 106 may be configured to perform digital processing on the signals received from the analog processing circuitry 104. For example, the digital processing circuitry 106 may be configured to perform one or more of wind reduction, input calibration, and anti-feedback processing.

The signals received by the beamforming circuitry 108 may thus represent a signal from the microphone 102₁ that has been subjected to analog and digital processing, and a signal from the microphone 102₂ that has been subjected to analog and digital processing. The beamforming circuitry 108 may be configured to perform beamforming on these signals. In some embodiments, the beamforming circuitry 108 may be configured to generate a front input audio signal based on a beam pattern steered towards a front direction of a wearer of the hearing aid. For example, if the microphone 102₁ is closer to the front of the wearer and the microphone 102₂ is closer to the back of the wearer, then the beamforming circuitry 108 may be configured to sum the processed signal from the microphone 102₁ with an inverted and delayed version of the processed signal from the microphone 102₂. The resulting signal may have no (or approximately no) signal attenuation towards the front of the wearer, complete (or approximately complete) signal attenuation directly to the back of the wearer, and be attenuated on the sides of the wearer by several dB (e.g., approximately 6 dB). Thus, the beamforming circuitry 108 may be configured to focus the sound processed by the ear-worn device towards the front of the wearer, where signals of interest typically originate. This front input audio signal may be referred to as a front-beamformed signal. The input audio signal denoised by the noise reduction circuitry 112 may be this front input audio signal. Example beam patterns for the front input audio signal may include, but not be limited to, a front-facing cardioid, a front-facing supercardioid, and a front-facing hypercardioid.

In some embodiments, the beamforming circuitry 108 may also be configured to generate a back input audio signal based on a beam pattern steered towards a back direction of a wearer of the hearing aid. For example, the beamforming circuitry 108 may be configured to sum the processed signal from the microphone 102₂ with an inverted and delayed version of the processed signal from the microphone 102₁. The resulting signal may have no (or approximately no) signal attenuation towards the back of the wearer, complete (or approximately complete) signal attenuation directly to the front of the wearer, and be attenuated on the sides of the wearer by several dB (e.g., approximately 6 dB). This back input audio signal may be referred to as a back-beamformed signal. However, in some embodiments, a back input audio signal may not be produced. Example beam patterns for the back input audio signal may include, but not be limited to, a back-facing cardioid, a back-facing supercardioid, and a back-facing hypercardioid.

The STFT circuitry 110 may be configured to perform STFT on the beamformed signals. The STFT may convert a signal within a short time window (e.g., on the order of milliseconds) into a frequency-domain signal. The STFT of the front-beamformed signal is labeled as “Front” for clarity in FIG. 1, and the STFT of the back-beamformed signal is labeled as “Back.” In some embodiments, the “Back” signal may not be used and therefore is shown by a dashed arrow.

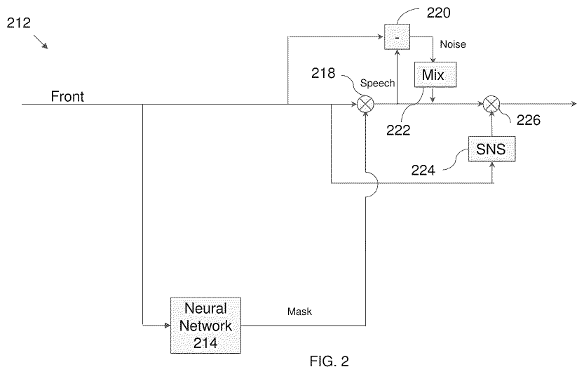

The noise reduction circuitry 112 may be configured to implement a neural network (i.e., one or more neural network layers) trained to denoise input audio signals. Any neural network layers described herein may be, for example, of the recurrent, vanilla/feedforward, convolutional, generative adversarial, attention (e.g. transformer), or graphical type. Further description of the noise reduction circuitry may be found with reference to FIG. 2.

The digital processing circuitry 134 may be configured to perform further digital processing on the signal received from the noise reduction circuitry 112. For example, the digital processing circuitry 134 may be configured to perform one or more of wide-dynamic range compression and output calibration.

The inverse STFT (iSTFT) circuitry 136 may be configured to perform inverse STFT on the signals received from the digital processing circuitry 134. The iSTFT may convert a frequency-domain signal into a time-domain signal having a short time window.

The receiver 138 may be configured to play back the signal received from the iSTFT circuitry 136 as sound into the ear of the user. The receiver 138 may also implement digital-to-analog conversion prior to the playing back.

FIG. 2 illustrates noise reduction circuitry 212 (which may correspond to the noise reduction circuitry 112), in accordance with certain embodiments described herein. The noise reduction circuitry 212 includes neural network circuitry 214 configured to implement a neural network trained to denoise input audio signals. In particular, the neural network may be trained to separate a speech component of an input audio signal from a noise component of the input audio. Further description of such neural networks may be found in U.S. Pat. No. 11,950,056, titled “Method, Apparatus and System for Neural Network Hearing Aid,” issued on Apr. 2, 2024, and based on an application filed on Jan. 14, 2022, which is incorporated by reference herein in its entirety. As referred to herein, a neural network trained to perform a particular function may be trained to perform the particular function directly or to generate an output (e.g., a mask) that may be used by downstream circuitry to perform the particular function. In some embodiments, denoising an input audio signal may include generating a mask that, when multiplied by the input audio signal, results in a speech component of the input audio signal. In more detail, the neural network circuitry 214 may be configured to take the front-beamformed signal (“Front”) as an input and output a mask that, when multiplied by Front, retains just the speech component of the input audio signal. The neural network implemented by the neural network circuitry 214 may be trained to output masks based on training input signals and their speech-isolated components. Thus, the mask may be a noise-reducing mask. In some embodiments, the mask may be configured to perform other functions, such as spatial focusing, in addition to noise reduction. Thus, the mask may be a noise-reducing and spatially-focusing mask.

The multiplier 218 may be configured to multiply an input audio signal by the mask. In particular, the multiplier 218 may be configured to multiply Front by the mask to produce a frequency-domain signal representing just the speech component of Front (referred to as “Speech”). The subtractor 220 may be configured to subtract Speech from Front, resulting in a frequency-domain signal representing everything but the speech component of Front (referred to as “Noise”). The mixing circuitry 222 may be configured to mix the speech component of the input audio signal with the noise component of the input audio signal, thereby producing a denoised audio signal. In more detail, the mixing circuitry 222 may be configured to mix together Speech and Noise using particular weights. For example, the output of the mixing circuitry 222 may be Speech+a*Noise, where a is a weight between 0 and 1. (In some embodiments, Speech and Noise may be STFTs.) The weight may be different for different frequency channels. Thus, the output of the mixing circuitry 222 may include less noise than Front, and thus may represent a noise-reduced version of Front. Mixing back some noise into the speech component of Front may help to reduce distortion and also enable some environmental awareness for the wearer of the ear-worn device. It should be appreciated that the noise component of the input audio signal (i.e., Noise) has been processed by the analog processing circuitry 104, the digital processing circuitry 106, the beamforming circuitry 108, and the STFT circuitry 110 prior to being mixed with the speech component of the input audio signal (i.e., Speech) by the mixing circuitry 222. In other words, no unprocessed signals may be involved in the mixing.

In some embodiments, separate stationary-noise suppression may be implemented. Thus, the stationary-noise suppression (SNS) circuitry 224 may be configured to reduce stationary noise in the output of the mixing circuitry 222. In some embodiments, the SNS circuitry 224 may be configured to implement one or more of multichannel adaptive noise reduction algorithms (which may detect the slow modulation in speech) and synchrony-detection noise reduction algorithms (which may detect co-modulation in speech). These algorithms may include, among non-limiting examples, valley estimation, spectral subtraction, Wiener filtering, and Ephraim-Malah techniques. Further description of such algorithms may be found in Chung, King. “Challenges and recent developments in hearing aids: Part I. Speech understanding in noise, microphone technologies and noise reduction algorithms.” Trends in Amplification 8.3 (2004): 83-124, which is incorporated by reference herein in its entirety. The output of the SNS circuitry 224 may be a mask that, when multiplied by the signal at the output of the mixing circuitry 222 using the multiplier 226, results in stationary noise suppression for the signal at the output of the mixing circuitry 222.

While FIG. 2 illustrates an example in which the neural network circuitry 214 is configured to generate a mask, and the multiplier 218 is configured to multiply the mask by Front to generate a signal of interest (e.g., the signal Speech), in some embodiments the neural network circuitry 214 may be configured to directly generate the signal of interest. In such embodiments, the multiplier 218 may be absent. While FIG. 2 illustrates an example in which the neural network implemented by the neural network circuitry 214 is trained to generate the mask such that, when the mask is multiplied by Front, the speech component of Front results, in some embodiments the neural network implemented by the neural network circuitry 214 may be trained to generate the mask such that, when the mask is multiplied by Front, the noise component of Front results. While FIG. 2 illustrates an example in which the subtractor 220 is configured to subtract Speech from Front to result in Noise, in some embodiments (e.g., when the mask generates Noise) the subtractor 220 may be configured to subtract Noise from Front to result in Speech. While FIG. 2 illustrates an example in which the mixing circuitry 222 is configured to mix Speech with Noise (e.g., using the formula Speech+a*Noise), because Front=Speech+Noise, in some embodiments, other combinations (e.g., two or more) of Speech, Noise, and Front may be mixed together to produce the same result. For example, the same result as Speech+a*Noise may result by mixing Front and Noise using the formula Front+b*Noise if b=a−1. These same variations may apply to any of the noise reduction circuitry described herein (e.g., any of the noise reduction circuitries 312-712 and 912-1012).

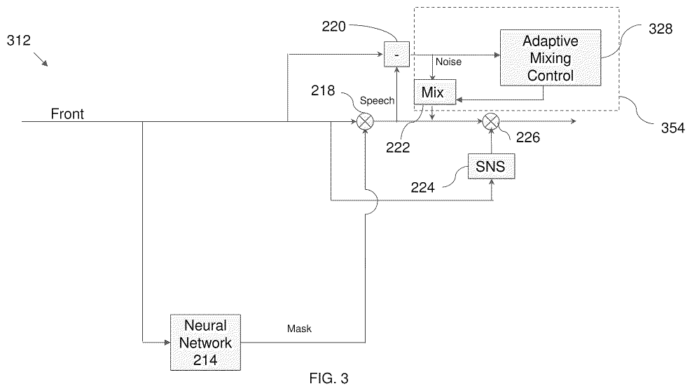

FIG. 3 illustrates noise reduction circuitry 312 (which may correspond to the noise reduction circuitry 112), in accordance with certain embodiments described herein. The noise reduction circuitry 312 is the same as the noise reduction circuitry 212, with the addition of adaptive mixing control circuitry 328. Generally, the adaptive mixing control circuitry 328 may be configured to control how much noise is mixed in with speech, after speech and noise have been separated using the neural network circuitry 214. In some embodiments, the adaptive mixing control circuitry 328 may be configured to control the mixing circuitry 222 to mix the speech component of the input audio signal with the noise component of the input audio signal based on a deviation of a short-term level of the noise component of the input audio signal from a long-term level of the noise component of the input audio signal. The adaptive mixing control circuitry 328 may be configured to control the mixing circuitry 222 to change, based on the deviation, an amount by which the amplitude (e.g., in time domain) of the noise component of the input audio signal is reduced when the noise component is mixed together with the speech component of the input audio signal. In some embodiments, the adaptive mixing control circuitry 328 may be configured to control the mixing circuitry 222 to increase, when the deviation increases, the amount by which the amplitude of the noise component the input audio signal is reduced when the noise component is mixed together with the speech component of the input audio signal. In some embodiments, reducing the amplitude of the noise component in time domain may be performed by multiplying the STFT of the noise component in time-frequency space.

As described above, in some embodiments the mixing circuitry 222 may be configured to mix the speech component of the input audio signal with the noise component of the input audio signal using at least one weight (e.g., the weight “a” in the formula Speech+a*Noise). In such embodiments, the adaptive mixing control circuitry may be configured to control the at least one weight based on the deviation. In some embodiments, the at least one weight may be applied to the noise component of the input audio signal, and the at least one weight may be inversely related to the deviation. Thus, in some embodiments, the larger the deviation as measured by the adaptive mixing control circuitry 328, the less noise that the adaptive mixing control circuitry 328 may control the mixing circuitry 222 to mix together with the speech (e.g., the smaller the adaptive mixing weight in the formula Speech+a*Noise that the adaptive mixing control circuitry 328 may control the mixing circuitry 222 to use), and the more aggressive the denoising implemented by the noise reduction circuitry 312 may be (for that period). In other words, the adaptive mixing weight may be inversely related (in some embodiments, inversely proportional) to the deviation. For example, consider an audio signal of an individual speaking and in the middle of the speech something causes extra noise for 50 milliseconds. During most of the speech, the mixing weight may be a constant (e.g., 0.18, corresponding to 15 dB attenuation of noise), but during the noise, the mixing weight may go down to 0.03 (30 dB attenuation of noise), and then recover back to 0.18. Importantly, while the attenuation goes down to 0.03, the speech volume may be preserved. For example, in the formula Speech+a*Noise, the weight applied to Speech by the mixing circuitry 222 may be a constant (e.g., 1); in other words, it may not change with changes in the adaptive mixing weight applied to Noise based on the deviation. Generally, in some embodiments, the mixing control circuitry might not be configured to change how much of the speech component of the input audio signal is mixed together with the noise component of the input audio signal based on the deviation.

In some embodiments, the adaptive mixing control circuitry 328 may be configured to calculate and store a long-term level of the noise component of the input audio signal, e.g., the long-term average of the noise level over a long time window, such as a window that is approximately equal to 100 milliseconds long, approximately equal to 1000 milliseconds long, or between approximately 100 and 1000 milliseconds long.

In some embodiments, the adaptive mixing control circuitry 328 may be configured to calculate and store a short-term level of the noise component of the input audio signal, e.g., a short-term average of the noise level over a short time window. The short time window is shorter than the long time window. For example, the short time window may be approximately equal to 10 milliseconds long, approximately equal to 25 milliseconds long, or between approximately 10 and 25 milliseconds long. In some embodiments, the short time window may overlap with the long time window. In some embodiments, they may overlap completely (in other words, the short time window may be completely within the long time window). In some embodiments, they may overlap partially.

It should be appreciated that the adaptive mixing control circuitry 328 does not analyze the entire input audio signal (i.e., speech and noise), but just analyzes the noise component once speech has been separated from noise by the neural network circuitry 214. It should also be appreciated that the adaptive mixing control circuitry 328 does not perform any binary detection of certain types of noise (e.g., by outputting a 1 or 0 based on whether a certain type of noise has been detected), but instead its output may take on a range of values based on how large the deviation of the short-term average noise level from the long-term average noise level is.

As one non-limiting example of how the adaptive mixing weight may depend on the deviation of the short-term noise level from the long-term noise level, one function may be that the adaptive mixing weight is a*min (1.0, compression_ratio*noise_estimate_long/noise_estimate_short), where a is the default mixing weight, noise_estimate_short is the short-term noise level and noise_estimate_long is the long-term noise level. Thus, when the short-term noise level becomes very high, the denominator of the function becomes large and the mixing weight will become small (i.e., little noise is mixed in with the speech). The compression_ratio is a number that has to be larger than 1 and may determine how aggressive the response is. The min (i.e., minimum) function ensures that when the long-term noise level is smaller than the short-term noise level, the mixing does not change from the default weight value. The function may dictate how the adaptive mixing weight reacts both to noise starting and ending. It should be appreciated that other functions may be used as well.

The above description has focused on the adaptive mixing control circuitry 328 configured to control the weight “a” when the mixing circuitry 222 is configured to mix Speech and Noise according to the formula Speech+a*Noise. As described above, in some embodiments the mixing circuitry 222 may be configured to mix other combinations (e.g., two or more) of Front, Speech, and Noise using other formulas. In such embodiments, the adaptive mixing control circuitry 328 may be configured to control different weights. For example, if the mixing circuitry 222 is configured to mix Front and Noise according to the formula Front+b*Noise, then the adaptive mixing control circuitry 328 may be configured to control the weight b. These same variations may apply to any of the noise reduction circuitry described herein (e.g., any of the noise reduction circuitries 512, 712, and 1012).

In some embodiments, the mixing circuitry 222 and the adaptive mixing control circuitry 328 may be implemented by separate components. In some embodiments, the mixing circuitry 222 and the adaptive mixing control circuitry 328 may be implemented by the same component. To encompass either scenario, FIG. 3 illustrates mixing and adaptive mixing control circuitry 354 encompassing the mixing circuitry 222 and the adaptive mixing control circuitry 328, where the mixing circuitry 222 and the adaptive mixing control circuitry 328 may be implemented by separate components or the same component. The mixing and adaptive mixing control circuitry 354 may be configured to perform the functions of the mixing circuitry 222 and the adaptive mixing control circuitry 354. For example, the mixing and adaptive mixing control circuitry 354 may be configured to mix the speech component of the input audio signal with the noise component of the input audio signal based on a deviation of a short-term level of the noise component of the input audio signal from a long-term level of the noise component of the input audio signal. For simplicity, the mixing and adaptive mixing control circuitry 354 is not illustrated in subsequent figures.

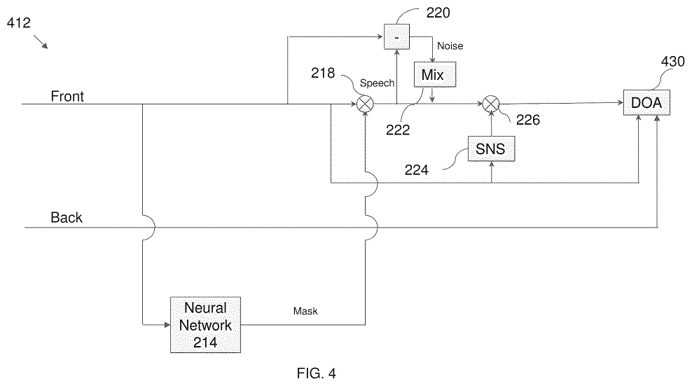

FIG. 4 illustrates noise reduction circuitry 412 (which may correspond to the noise reduction circuitry 112), in accordance with certain embodiments described herein. The noise reduction circuitry 412 is the same as the noise reduction circuitry 212, with the addition of direction-of-arrival (DOA) circuitry 430. The DOA circuitry 430 may be configured to implement DOA boosting. In some embodiments, the DOA circuitry 430 may be configured to receive a front input audio signal based on a beam pattern steered towards a front direction of a wearer of the hearing aid, receive a back input audio signal based on a beam pattern steered towards a back direction of the wearer of the hearing aid, and bias an output audio signal based on a difference between the front audio signal and the back audio signal. In some embodiments, the DOA circuitry 430 may be configured to assign a weight to each of multiple time-frequency bins based on the front and back input audio signals depending on whether sound in each of the multiple time-frequency bins came from the front direction or the back direction, and bias the output audio signal based on the weights. In some embodiments, the DOA circuitry 430 may be configured to subtract magnitudes of the back audio signal from magnitudes of the front audio signal. In some embodiments, the DOA circuitry may be configured, when biasing the output audio signal, to combine the output audio signal with a result of the subtraction. The DOA circuitry 430 may be configured to use addition or multiplication, for example, when combining the output audio signal with the result of the subtraction.

In more detail, and as described above, the signals Front and Back may represent two beam patterns steered towards the front and back, respectively, of the user, and the DOA circuitry 430 may receive Front and Back. The DOA circuitry 430 may be configured to assign a weight to each time-frequency bin depending on whether the sound in that bin is coming from a direction that should be boosted or a direction that should be attenuated. For example, the DOA circuitry 430 may be configured to subtract the magnitudes of Back from Front so that the result is a time-frequency map with positive and negative values. The positive values may correspond to bins where sound is coming primarily from the front of the wearer and negative values may correspond to bins where sound is coming primarily from the back of the wearer. The DOA circuitry 430 may be configured to use this time-frequency map to bias the output audio so that sounds coming from the front are preferentially boosted while sounds coming from the back are preferentially attenuated. Generally, the DOA circuitry 430 may be configured to combine the time-frequency map with the output audio. As an example, the DOA circuitry 430 may be configured to calculate the difference between the magnitudes of Front and Back. Let this quantity be D. The DOA circuitry 430 may be configured to then add D*c to Front, where c is a constant that determines how aggressive the DOA boosting is going to be. The result is that when D is positive, those bins are boosted and when D is negative those bins are attenuated. The DOA circuitry 430 may also be configured to implement caps for how large or how small the result is going to be. For example, the DOA circuitry 430 may be configured not to boost by more than 3 dB and not to attenuate by more than 6 dB. As another example, the bias may be in the form of a mask that the DOA may be configured to generate based on the time-frequency and multiply by the output of the multiplier 226. The DOA circuitry 430 may provide a way to achieve “super-directionality”; beamforming (e.g., as implemented by the beamforming circuitry 108) may provide some directionality, but if DOA boosting is applied in addition to the beamforming as described above, the result may be even more directional.

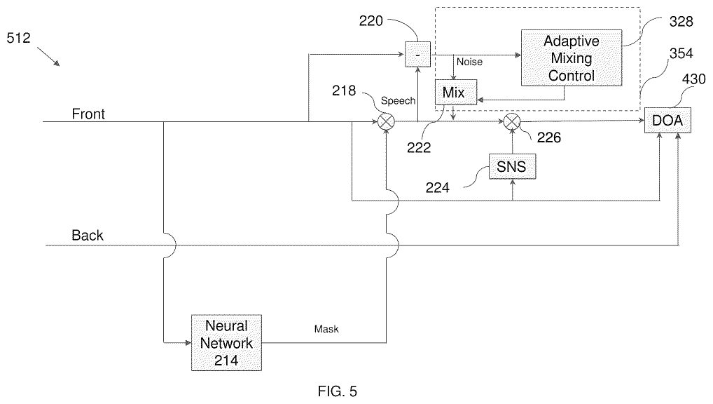

FIG. 5 illustrates noise reduction circuitry 512 (which may correspond to the noise reduction circuitry 112), in accordance with certain embodiments described herein. The noise reduction circuitry 512 is a combination of the noise reduction circuitry 312 and 412 in that it includes both the adaptive mixing control circuitry 328 and the DOA circuitry 430.

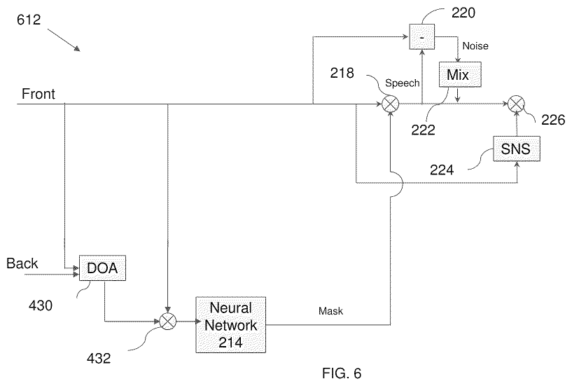

FIG. 6 illustrates noise reduction circuitry 612 (which may correspond to the noise reduction circuitry 112), in accordance with certain embodiments described herein. The noise reduction circuitry 612 is the same as the noise reduction 412, but the DOA circuitry 430 is implemented upstream of the neural network circuitry 214. As illustrated, the Front and Back signals are fed to the DOA circuitry 430 upstream of the neural network circuitry 214, and the multiplier 432 multiplies the output mask from the DOA circuitry 430 by Front. The result of the multiplication is fed to the neural network circuitry 214 for denoising.

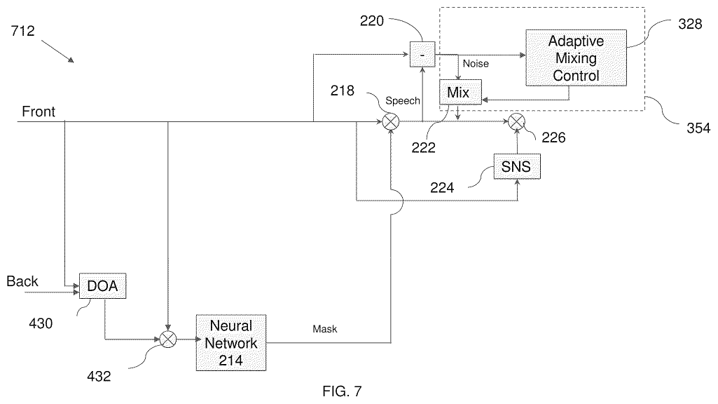

FIG. 7 illustrates noise reduction circuitry 712 (which may correspond to the noise reduction circuitry 112), in accordance with certain embodiments described herein. The noise reduction circuitry 712 is a combination of the noise reduction circuitry 312 and 612 in that it includes both the adaptive mixing control circuitry 328 and the DOA circuitry 430 implemented before the neural network circuitry 214.

In some embodiments, such as the data path 100, noise reduction is applied after beamforming. In other words, the beamforming circuitry may be upstream of the noise reduction circuitry. This may be helpful because noise reduction typically works better when it receives a higher SNR signal. However, the beamforming algorithm may steer the nulls based on the overall level of sound and may not, in general, point the nulls toward interfering speakers. In some embodiments, such as the data path 800 described below, noise reduction is applied before beamforming. In other words, the beamforming circuitry may be downstream of the noise reduction circuitry. Thus, after the noise reduction, the output signal is dominated by speech, and then this result undergoes beamforming to null-out the interfering speaker(s). In more detail, assume that the wearer wants to listen in the forward direction. Beamforming may steer nulls to minimize the overall volume of sound. In a scenario in which there is a speaker the wearer is talking to and another speaker behind the wearer, the total volume may be lowest when the null is steered in the direction of the speaker behind the wearer. So, the adaptive beamformer may constantly be steering the nulls to make the overall volume as quiet as possible.

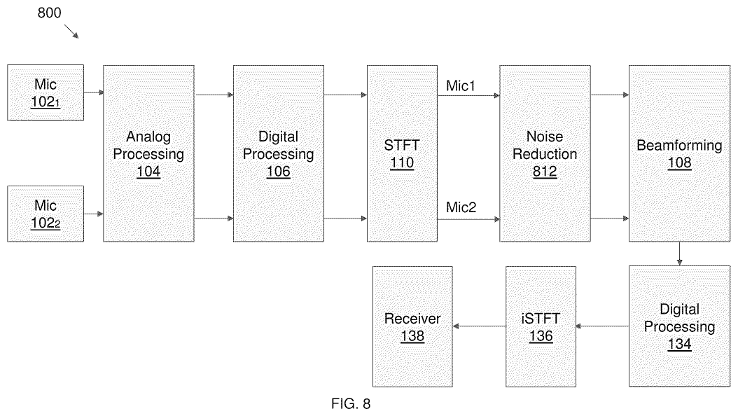

FIG. 8 illustrates a data path 800 in an ear-worn device (e.g., a hearing aid), in accordance with certain embodiments described herein. The data path 800 is the same as the data path 100, except that in the data path 800, the beamforming circuitry 108 is downstream of the noise reduction circuitry 812, while in the data path 100, the beamforming circuitry 108 is upstream of the noise reduction circuitry 112. The noise reduction circuitry 812 in the data path 800 and the noise reduction circuitry 112 in the data path 100 may be different because the noise reduction circuitry 812 receives non-beamformed signals (labeled “Mic1” and “Mic2”, representing signals from the microphone 102₁ and the microphone 102₂, respectively, after processing) while the noise reduction circuitry 112 receives beamformed signals (“Front” and “Back”).

In the data path 800, the analog processing circuitry 104 is coupled between the microphones 102₁ and 102₂ and the digital processing circuitry 106. The digital processing circuitry 106 is coupled between the analog processing circuitry 104 and the STFT circuitry 110. The STFT circuitry 110 is coupled between the analog processing circuitry 104 and the noise reduction circuitry 812. The noise reduction circuitry 812 is coupled between the STFT circuitry 110 and the beamforming circuitry 108. The beamforming circuitry 108 is coupled between the noise reduction circuitry 812 and the digital processing circuitry 134. The digital processing circuitry 134 is coupled between the beamforming circuitry 108 and the inverse STFT circuitry 136. The inverse STFT 136 circuitry is coupled between the digital processing circuitry 134 and the receiver 138.

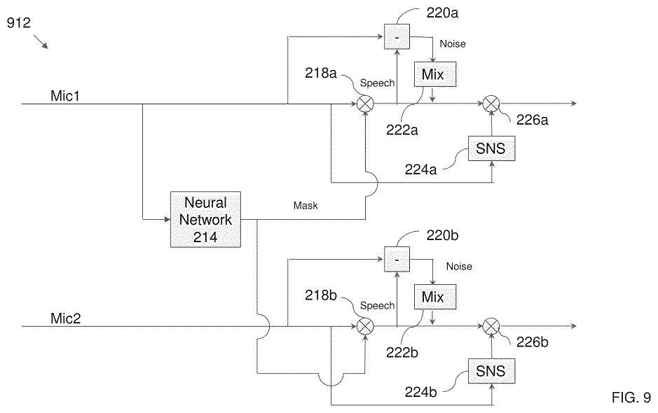

FIG. 9 illustrates noise reduction circuitry 912 (which may correspond to the noise reduction circuitry 812), in accordance with certain embodiments described herein. Generally, the noise reduction circuitry 912 may be configured to receive at least a first microphone signal Mic1 and a second microphone signal Mic2 and generate a first noise-reduced audio signal and a second noise-reduced audio signal based on the first and second microphone signals, respectively. The noise reduction circuitry 912 may be configured to process the signal Mic1 in the same way that the noise reduction circuitry 212 processes the signal Front. Under the assumption that the signals Mic1 and Mic2 are highly similar, the noise reduction circuitry 912 may be configured to apply the mask generated from Mic1 to both the signals Mic1 and Mic2, rather than running both Mic1 and Mic2 through the neural network circuitry separately; this may conserve power and latency. Aside from this difference, the noise reduction circuitry 912 may be configured to process Mic2 in the same way that it processes Mic1, with mixing and SNS applied to both Mic1 and Mic2 separately. In some embodiments, both Mic1 and Mic2 may be processed by neural network circuitry to generate separate masks for use in denoising Mic1 and Mic2 independently.

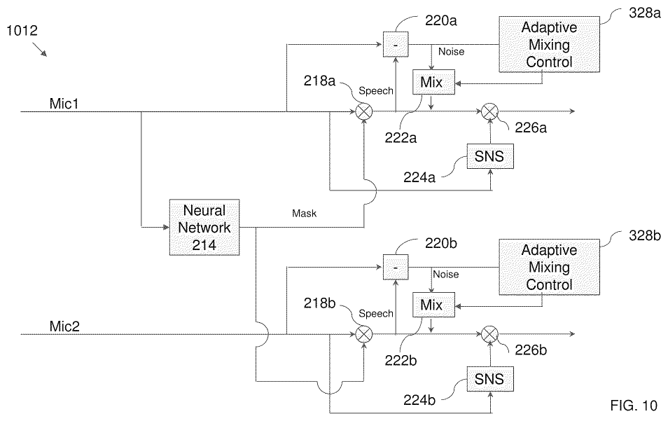

FIG. 10 illustrates noise reduction circuitry 1012 (which may correspond to the noise reduction circuitry 812), in accordance with certain embodiments described herein. The noise reduction circuitry 1012 is the same as the noise reduction circuitry 912, except that the noise reduction circuitry 1012 includes adaptive mixing control circuitry 328a and 328b, which are applied to denoised versions of Mic1 and Mic2 separately. In other words, the noise reduction circuitry 1012 may be configured to receive at least a first input audio signal originating from a first microphone signal and a second input audio signal originating from a second microphone signal, and the adaptive mixing control circuitry 328a and 328b may be configured to operate independently on noise-reduced versions of the first and second input audio signals. For simplicity, FIG. 10 does not illustrate the mixing and adaptive mixing control circuitry 354.

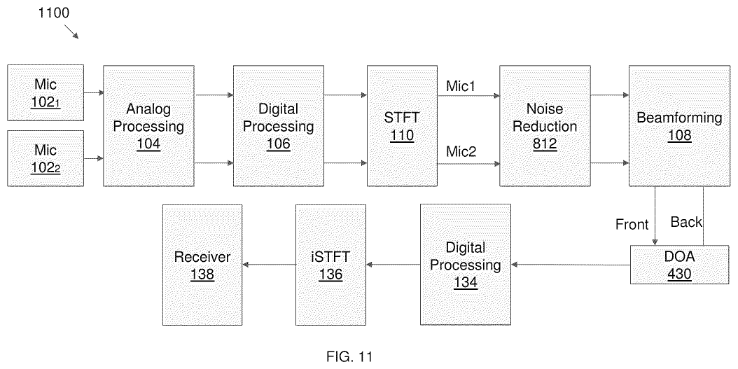

FIG. 11 illustrates a data path 1100 in an ear-worn device (e.g., a hearing aid), in accordance with certain embodiments described herein. The data path 1100 is the same as the data path 800, except that the data path 1100 includes the DOA circuitry 430. Thus, the data path 1100 is configured to implement DOA boosting. The data path 1100 may also be configured to implement adaptive mixing control, as described with reference to the noise reduction circuitry 1012. It should be appreciated from the above description that in some embodiments, noise reduction circuitry may be upstream of beamforming circuitry and DOA circuitry. In some embodiments, noise reduction circuitry may be downstream of the beamforming circuitry and the DOA circuitry.

Conventional hearing aids may use masks that are real. In some embodiments, any of the masks described herein that are output by neural network circuitry (e.g., the neural network circuitry 214) may be real. However, in some embodiments, any of the masks described herein that are output by neural network circuitry (e.g., the neural network circuitry 214) may be complex. Multiplying an input audio signal by a complex mask may involve modifying phase. A purely real mask may maintain the phase of a noisy mixture and distort speech when signal-to-noise ratio (SNR) is low. This is because, considering an input audio signal in STFT space, the high SNR frequency bins are mostly speech and the low SNR frequency bins are mostly noise. If the goal is to estimate the STFT of the clean speech, using the phase of the inputs may be acceptable for the high SNR bins (since they are mostly speech), but using the phase of the inputs will be very inaccurate for low SNR bins (which are mostly noise). A complex mask may, in principle, do perfect denoising.

While the above description has focused on frequency-domain processing, and accordingly the data paths described above have included STFT and iSTFT circuitry, in some embodiments processing may occur in the time domain, and STFT and iSTFT circuitry may be absent. Diagrams of such embodiments would resemble the figures illustrated herein, with the STFT circuitry 110 and the inverse STFT circuitry 136 removed.

Any of the neutral network circuitry described herein (e.g., the neural network circuitry 214) may include circuitry configured to perform operations necessary for computing the output of a neural network layer. One such operation may be a matrix-vector multiplication. In some embodiments, neural network circuitry may include multiple identical tiles each including multiple multiply-and-accumulate circuits configured to perform intermediate computations of a matrix-vector multiplication in parallel and then compute results of the intermediate computations into a final result. Each tile may additionally include memory configured to store neural network weights, registers configured to store input activation elements, and routing circuitry configured to facilitate communication of status and data between tiles. Other types of circuitry configured to perform processing described herein, such as multipliers (e.g., the multipliers 218, 226, and/or 432), subtractors (e.g., the subtractor 220), mixing circuitry (e.g., the mixing circuitry 222), SNS circuitry (e.g., the SNS circuitry 224), adaptive mixing control circuitry (e.g., the adaptive mixing control circuitry 328), and/or DOA circuitry (e.g., the DOA circuitry 430) may be implemented as digital processing circuitry. In some embodiments, such digital processing circuitry may use a SIMD (single instruction multiple data) architecture. Any of the ear-worn devices described herein (e.g., any of the ear-worn devices including any of the data paths, such as the data paths 100, 800, and/or 1100) may include a chip implementing certain portions of circuitry. For example, any of the noise reduction circuitry (e.g., any of the noise reduction circuitry 112-712 and 912-1012) described herein (in some embodiments, among other types of circuitry) may be implemented (in whole or in part) on a chip. Thus, the chip may include the tiles and digital processing circuitry described above. In some embodiments, for a model having up to 10M 8-bit weights, and when operating at 100 GOPs/sec on time series data, the chip may achieve power efficiency of 4 GOPs/milliwatt, measured at 40 degrees Celsius, when the chip uses supply voltages between 0.5-1.8V, and when the chip is performing operations without idling. Further description of chips incorporating (in some embodiments, among other elements) neural network circuitry for use in ear-worn devices may be found in U.S. Pat. No. 11,886,974, entitled “Neural Network Chip for Ear-Worn Device,” issued Jan. 30, 2024, which is incorporated by reference herein in its entirety. In some embodiments, in addition to such a chip including some or all of the noise reduction circuitry, any of the ear-worn devices described herein may include a digital signal processor configured to perform other operations, such as some or all of the processing performed by the analog processing circuitry 104, digital processing circuitry 106, STFt circuitry 110, beamforming circuitry 108, digital processing circuitry 134, and/or iSTFt circuitry 136.

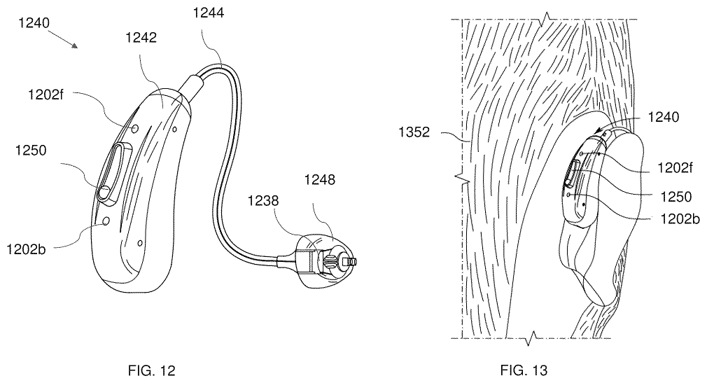

FIG. 12 illustrates a view of a hearing aid 1240, in accordance with certain embodiments described herein. The hearing aid 1240 may be any of the ear-worn devices or hearing aids described herein. For example, the hearing aid 1240 may be the ear-worn device including any of the data paths (any of the data paths 100, 800, and/or 1100) described herein. The hearing aid 1240 is a receiver-in-canal (RIC) (also referred to as a receiver-in-the-ear (RITE)) type of hearing aid. However, any other type of hearing aid (e.g., behind-the-ear, in-the-ear, in-the-canal, completely-in-canal, open fit, etc.) may also be used. The hearing aid 1240 includes a body 1242, a receiver wire 1244, a receiver 1238, and a dome 1248. The body 1242 is coupled to the receiver wire 1244 and the receiver wire 1244 is coupled to the receiver 1238. The dome 1248 is placed over the receiver 1238. The body 1242 includes a front microphone 1202f, a back microphone 1202b, and a user input device 1250. The body 1242 additionally includes circuitry (e.g., any of the circuitry described above, aside from the receiver 1238) not illustrated in FIG. 12. When the hearing aid 1240 is worn, the front microphone 1202f may be closer to the front of the wearer and the back microphone 1202b may be closer to the back of the wearer. The front microphone 1202f and the back microphone 1202b may be configured to receive sound signals and generate audio signals based on the sound signals. Any of the two or more microphones described herein may be the front microphone 1202f and the back microphone 1202b of the hearing aid 1240. For example, the microphone 102₁ may be front microphone 1202f and the back microphone 102₂ may be back microphone 1202b. The user input device 1250 (e.g., a button) may be configured to control certain functions of the hearing aid 1240, such as volume, activation of neural network-based denoising, etc.

The receiver wire 1244 may be configured to transmit audio signals from the body 1242 to the receiver 1238. The receiver 1238 may be configured to receive audio signals (i.e., those audio signals generated by the body 1242 and transmitted by the receiver wire 1244) and generate sound signals based on the audio signals. The dome 1248 may be configured to fit tightly inside the wearer's ear and direct the sound signal produced by the receiver 1238 into the ear canal of the wearer. The receiver 1238 may be the same as the receiver 138.

In some embodiments, the length of the body 1242 may be equal to 2 cm, equal to 5 cm, or between 2 and 5 cm in length. In some embodiments, the weight of the hearing aid 1240 may be less than 4.5 grams. In some embodiments, the spacing between the microphones may be equal to 5 mm, equal to 12 mm, or between 5 and 12 mm. In some embodiments, the body 1242 may include a battery (not visible in FIG. 1), such as a lithium ion rechargeable coin cell battery.

FIG. 13 illustrates the hearing aid 1240 on a wearer 1352, in accordance with certain embodiments described herein. FIG. 13 shows the wearer 1352 from the back, and as illustrated, the front microphone 1202f is closer to the front of the wearer 208 and the back microphone 1202b is closer to the back of the wearer 1352. While FIGS. 12 and 13 illustrate a RIC hearing aid, hearing aids with other form factors may be used as well.

Example is directed to an ear-worn device, comprising: noise reduction circuitry comprising: neural network circuitry configured to implement a neural network trained to separate a speech component of an input audio signal from a noise component of the input audio signal; mixing circuitry configured to mix the speech component of the input audio signal with the noise component of the input audio signal; and adaptive mixing control circuitry configured to: control the mixing circuitry to mix the speech component of the input audio signal with the noise component of the input audio signal based on a deviation of a short-term level of the noise component of the input audio signal from a long-term level of the noise component of the input audio signal.

Example 2 is directed to the ear-worn device of example 1, wherein the adaptive mixing control circuitry is configured to control the mixing control circuitry to change, based on the deviation, an amount by which an amplitude of of the noise component of the input audio signal is reduced when the noise component is mixed together with the speech component of the input audio signal.

Example 3 is directed to the ear-worn device of any of examples 1-2, wherein the adaptive mixing control circuitry is configured to control the mixing control circuitry to increase, when the deviation increases, the amount by which the amplitude of the noise component is reduced when the noise component is mixed together with the speech component of the input audio signal.

Example 4 is directed to the ear-worn device of any of examples 1-3, wherein: the mixing circuitry is configured to mix the speech component of the input audio signal with the noise component of the input audio signal using at least one weight; and the adaptive mixing control circuitry is configured to control the at least one weight based on the deviation.

Example 5 is directed to the ear-worn device of example 4, wherein the at least one weight is applied to the noise component of the input audio signal, and the at least one weight is inversely related to the deviation.

Example 6 is directed to the ear-worn device of any of examples 1-5, wherein the adaptive mixing control circuitry is further configured to calculate the long-term level of the noise component of the input audio signal over a window that is approximately equal to 100 milliseconds long, approximately equal to 1000 milliseconds long, or between approximately 100 and 1000 milliseconds long.

Example 7 is directed to the ear-worn device of any of examples 1-6, wherein the adaptive mixing control circuitry is further configured to calculate the short-term level of the noise component of the input audio signal over a window that is approximately equal to 10 milliseconds long, approximately equal to 25 milliseconds long, or between approximately 10 and 25 milliseconds long.

Example 8 is directed to the ear-worn device of any of examples 1-7, wherein a weight used for mixing the speech component of the input audio signal together with the noise component of the input audio signal is a constant.

Example 9 is directed to the ear-worn device of any of examples 1-8, wherein: the ear-worn device further comprises beamforming circuitry; and the beamforming circuitry is upstream of the noise reduction circuitry.

Example 10 is directed to the ear-worn device of example 9, wherein: the beamforming circuitry is configured to generate a front input audio signal based on a beam pattern steered towards a front direction of a wearer of the ear-worn device; and the input audio signal is the front input audio signal.

Example 11 is directed to the ear-worn device of any of examples 1-8, wherein: the ear-worn device further comprises beamforming circuitry; and the beamforming circuitry is downstream of the noise reduction circuitry.

Example 12 is directed to the ear-worn device of any of examples 1-8, wherein: the input audio signal comprises a first input audio signal originating from a first microphone signal; the noise reduction circuitry is configured to receive at least the first input audio signal and a second input audio signal originating from a second microphone signal; and the adaptive mixing control circuitry is configured to operate independently on noise-reduced versions of the first and second input audio signals.

Example 13 is directed to the ear-worn device of example 12, wherein the neural network circuitry is configured to generate a mask based on the first microphone signal and apply the mask to the first and second microphone signals.

Example 14 is directed to the ear-worn device of any of examples 1-13, wherein a first time window for the short-term level is shorter than a second time window for the long-term level.

Example 15 is directed to the ear-worn device of any of examples 1-14, wherein a first time window for the short-term level and a second time window for the long-term level overlap.

Example 16 is directed to an ear-worn device, comprising: noise reduction circuitry comprising: neural network circuitry configured to implement a neural network trained to separate a speech component of an input audio signal from a noise component of the input audio signal; and mixing and adaptive mixing control circuitry configured to mix the speech component of the input audio signal with the noise component of the input audio signal based on a deviation of a short-term level of the noise component of the input audio signal from a long-term level of the noise component of the input audio signal.

Example 17 is directed to the ear-worn device of example 16, wherein the mixing and adaptive mixing control circuitry is configured to change, based on the deviation, an amount by which an amplitude of of the noise component of the input audio signal is reduced when the noise component is mixed together with the speech component of the input audio signal.

Example 18 is directed to the ear-worn device of any of examples 16-17, wherein the mixing and adaptive mixing control circuitry is configured to increase, when the deviation increases, the amount by which the amplitude of the noise component is reduced when the noise component is mixed together with the speech component of the input audio signal.

Example 19 is directed to the ear-worn device of any of examples 16-18, wherein: the mixing and adaptive mixing control circuitry is configured to: mix the speech component of the input audio signal with the noise component of the input audio signal using at least one weight; and base the at least one weight on the deviation.

Example 20 is directed to the ear-worn device of example 19, wherein the at least one weight is applied to the noise component of the input audio signal, and the at least one weight is inversely related to the deviation.

Example 21 is directed to the ear-worn device of any of examples 16-20, wherein the mixing and adaptive mixing control circuitry is further configured to calculate the long-term level of the noise component of the input audio signal over a window that is approximately equal to 100 milliseconds long, approximately equal to 1000 milliseconds long, or between approximately 100 and 1000 milliseconds long.

Example 22 is directed to the ear-worn device of any of examples 16-21, wherein the mixing and adaptive mixing control circuitry is further configured to calculate the short-term level of the noise component of the input audio signal over a window that is approximately equal to 10 milliseconds long, approximately equal to 25 milliseconds long, or between approximately 10 and 25 milliseconds long.

Example 23 is directed to the ear-worn device of any of examples 16-22, wherein a weight used for mixing the speech component of the input audio signal together with the noise component of the input audio signal is a constant.

Example 24 is directed to the ear-worn device of any of examples 16-23, wherein: the ear-worn device further comprises beamforming circuitry; and the beamforming circuitry is upstream of the noise reduction circuitry.

Example 25 is directed to the ear-worn device of example 24, wherein: the beamforming circuitry is configured to generate a front input audio signal based on a beam pattern steered towards a front direction of a wearer of the ear-worn device; and the input audio signal is the front input audio signal.

Example 26 is directed to the ear-worn device of any of examples 16-23, wherein: the ear-worn device further comprises beamforming circuitry; and the beamforming circuitry is downstream of the noise reduction circuitry.

Example 27 is directed to the ear-worn device of any of examples 16-23, wherein: the input audio signal comprises a first input audio signal originating from a first microphone signal; the noise reduction circuitry is configured to receive at least the first input audio signal and a second input audio signal originating from a second microphone signal; and the mixing and adaptive mixing control circuitry is configured to operate independently on noise-reduced versions of the first and second input audio signals.

Example 28 is directed to the ear-worn device of example 27, wherein the neural network circuitry is configured to generate a mask based on the first microphone signal and apply the mask to the first and second microphone signals.

Example 29 is directed to the ear-worn device of any of examples 16-28, wherein a first time window for the short-term level is shorter than a second time window for the long-term level.

Example 30 is directed to the ear-worn device of any of examples 16-29, wherein a first time window for the short-term level and a second time window for the long-term level overlap.

Example 31 is directed to an ear-worn device comprising: beamforming circuitry configured to generate, based on at least a first microphone signal and a second microphone signal: a front audio signal based on a first beam pattern steered towards a front direction of a wearer of the ear-worn device; and a back audio signal based on a second beam pattern steered towards a back direction of the wearer of the ear-worn device; and direction-of-arrival (DOA) circuitry configured to: receive the front audio signal; receive the back audio signal; and bias an output audio signal based on a difference between the front audio signal and the back audio signal.

Example 32 is directed to the ear-worn device of example 31, wherein: the DOA circuitry is configured further configured to assign a weight to each of multiple time-frequency bins based whether sound in each of the multiple time-frequency bins came from the front direction or the back direction; and the DOA circuitry is configured, when biasing the output audio signal, to bias the output audio signal based on the weights.

Example 33 is directed to the ear-worn device of any of examples 31-32, wherein the DOA circuitry is further configured to subtract magnitudes of the back audio signal from magnitudes of the front audio signal.

Example 34 is directed to the ear-worn device of example 33, wherein the DOA circuitry is configured, when biasing the output audio signal, to combine the output audio signal with a result of the subtraction.

Example 35 is directed to the ear-worn device of example 34, wherein the DOA circuitry is configured to use addition or multiplication when combining the output audio signal with the result of the subtraction.

Example 36 is directed to the ear-worn device of any of examples 31-35, wherein the ear-worn device further comprises noise reduction circuitry upstream of the beamforming circuitry and the DOA circuitry.

Example 37 is directed to the ear-worn device of any of examples 31-35, wherein the ear-worn device further comprises noise reduction circuitry downstream of the beamforming circuitry and the DOA circuitry.

Having described several embodiments of the techniques in detail, various modifications and improvements will readily occur to those skilled in the art. Such modifications and improvements are intended to be within the spirit and scope of the invention. Accordingly, the foregoing description is by way of example only, and is not intended as limiting. For example, any components described above may comprise hardware, software or a combination of hardware and software.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

The terms “approximately” and “about” may be used to mean within ±20% of a target value in some embodiments, within ±10% of a target value in some embodiments, within ±5% of a target value in some embodiments, and yet within ±2% of a target value in some embodiments. The terms “approximately” and “about” may include the target value.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

Having described above several aspects of at least one embodiment, it is to be appreciated various alterations, modifications, and improvements will readily occur to those skilled in the art. Such alterations, modifications, and improvements are intended to be objects of this disclosure. Accordingly, the foregoing description and drawings are by way of example only.

1. An ear-worn device, comprising:
noise reduction circuitry comprising:
neural network circuitry configured to implement a neural network trained to separate a speech component of an input audio signal from a noise component of the input audio signal;
mixing circuitry configured to mix the speech component of the input audio signal with the noise component of the input audio signal; and
adaptive mixing control circuitry configured to:
control the mixing circuitry to mix the speech component of the input audio signal with the noise component of the input audio signal based on a deviation of a short-term level of the noise component of the input audio signal from a long-term level of the noise component of the input audio signal.

2. The ear-worn device of claim 1, wherein the adaptive mixing control circuitry is configured to control the mixing control circuitry to change, based on the deviation, an amount by which an amplitude of of the noise component of the input audio signal is reduced when the noise component is mixed together with the speech component of the input audio signal.

3. The ear-worn device of claim 1, wherein the adaptive mixing control circuitry is configured to control the mixing control circuitry to increase, when the deviation increases, the amount by which the amplitude of the noise component is reduced when the noise component is mixed together with the speech component of the input audio signal.

4. The ear-worn device of claim 1, wherein:
the mixing circuitry is configured to mix the speech component of the input audio signal with the noise component of the input audio signal using at least one weight; and
the adaptive mixing control circuitry is configured to control the at least one weight based on the deviation.

5. The ear-worn device of claim 4, wherein the at least one weight is applied to the noise component of the input audio signal, and the at least one weight is inversely related to the deviation.

6. The ear-worn device of claim 1, wherein the adaptive mixing control circuitry is further configured to calculate the long-term level of the noise component of the input audio signal over a window that is approximately equal to 100 milliseconds long, approximately equal to 1000 milliseconds long, or between approximately 100 and 1000 milliseconds long.

7. The ear-worn device of claim 1, wherein the adaptive mixing control circuitry is further configured to calculate the short-term level of the noise component of the input audio signal over a window that is approximately equal to 10 milliseconds long, approximately equal to 25 milliseconds long, or between approximately 10 and 25 milliseconds long.

8. The ear-worn device of claim 1, wherein a weight used for mixing the speech component of the input audio signal together with the noise component of the input audio signal is a constant.

9. The ear-worn device of claim 1, wherein:
the car-worn device further comprises beamforming circuitry; and
the beamforming circuitry is upstream of the noise reduction circuitry.

10. The ear-worn device of claim 9, wherein:
the beamforming circuitry is configured to generate a front input audio signal based on a beam pattern steered towards a front direction of a wearer of the ear-worn device; and
the input audio signal is the front input audio signal.

11. The ear-worn device of claim 1, wherein:
the ear-worn device further comprises beamforming circuitry; and
the beamforming circuitry is downstream of the noise reduction circuitry.

12. The ear-worn device of claim 1, wherein:
the input audio signal comprises a first input audio signal originating from a first microphone signal;
the noise reduction circuitry is configured to receive at least the first input audio signal and a second input audio signal originating from a second microphone signal; and
the adaptive mixing control circuitry is configured to operate independently on noise-reduced versions of the first and second input audio signals.

13. The ear-worn device of claim 12, wherein the neural network circuitry is configured to generate a mask based on the first microphone signal and apply the mask to the first and second microphone signals.

14. The ear-worn device of claim 1, wherein a first time window for the short-term level is shorter than a second time window for the long-term level.

15. The ear-worn device of claim 1 wherein a first time window for the short-term level and a second time window for the long-term level overlap.

16. An ear-worn device, comprising:
noise reduction circuitry comprising:
neural network circuitry configured to implement a neural network trained to separate a speech component of an input audio signal from a noise component of the input audio signal; and
mixing and adaptive mixing control circuitry configured to mix the speech component of the input audio signal with the noise component of the input audio signal based on a deviation of a short-term level of the noise component of the input audio signal from a long-term level of the noise component of the input audio signal.

17. An ear-worn device comprising:
beamforming circuitry configured to generate, based on at least a first microphone signal and a second microphone signal:
a front audio signal based on a first beam pattern steered towards a front direction of a wearer of the ear-worn device; and
a back audio signal based on a second beam pattern steered towards a back direction of the wearer of the ear-worn device; and
direction-of-arrival (DOA) circuitry configured to:
receive the front audio signal;
receive the back audio signal; and
bias an output audio signal based on a difference between the front audio signal and the back audio signal.

18. The ear-worn device of claim 17, wherein:
the DOA circuitry is configured further configured to assign a weight to each of multiple time-frequency bins based whether sound in each of the multiple time-frequency bins came from the front direction or the back direction; and
the DOA circuitry is configured, when biasing the output audio signal, to bias the output audio signal based on the weights.

19. The ear-worn device of claim 17, wherein the DOA circuitry is further configured to subtract magnitudes of the back audio signal from magnitudes of the front audio signal.

20. The ear-worn device of claim 19, wherein the DOA circuitry is configured, when biasing the output audio signal, to combine the output audio signal with a result of the subtraction.

21. The ear-worn device of claim 20, wherein the DOA circuitry is configured to use addition or multiplication when combining the output audio signal with the result of the subtraction.

22. The ear-worn device of claim 17, wherein the ear-worn device further comprises noise reduction circuitry upstream of the beamforming circuitry and the DOA circuitry.

23. The ear-worn device of claim 17, wherein the ear-worn device further comprises noise reduction circuitry downstream of the beamforming circuitry and the DOA circuitry.
